(19) United States
(12) Patent Application Publication
(10) Pub. No.: US 2005/0156891 A1
(43) Pub. Date: Jul. 21, 2005

(54) Device for inputting information

(76) Inventors: Bernd Holz auf der Heide, Munchen (DE); Kathleen Stahlberg, Plainsboro, DE (US)

Correspondence Address: BELL, BOYD & LLOYD, LLC, P. O. BOX 1135, CHICAGO, IL, 60690-1135, US

(21) Appl. No.: 10/503,028

(22) PCT Filed: Jan. 15, 2003
(86) PCT No.: PCT/DE03/00097

(30) Foreign Application Priority Data
Jan. 28, 2002 (DE) 102 03 209.2

(51) Int. Cl. G09G 5/08

(52) U.S. Cl. 345/167

(57) ABSTRACT

A device (30) with an input element (10) for controlling a display unit, by means of which a cursor unit can be moved on the display unit, and
the movements of the input element (10) relative to a reference surface are detected by means of a motion detection unit, characterized by the fact that
the input element (10) is configured in a deformable manner and
switching elements (14) can be operated when the input element (10) is in a deformed state, by way of which functionalities can be controlled on the display unit.

The present invention relates to a device for inputting information according to the features of the preamble in claim 1.

The operation of a graphical user interface is not usually effected directly but instead by way of a further input tool, such as a so-called mouse. The mouse is moved with reference to a surface and this movement is detected and converted into a movement of a cursor unit on the display unit, such as a screen. The detection of the movement of the mouse takes place, for example, by way of a ball mounted in a moveable manner installed on the underside of the mouse, the movement of which ball is detected by way of mechanical and/or optical sensor elements in the interior of the mouse. To select specific functionalities, such as the opening of a file, keys installed on the mouse are used, with which keys the object (file) is clicked on, for example.

With regard to mobile appliances, it is appropriate not to use a separate mouse as a control unit but instead to integrate the control unit. In the case of laptops, a ball mounted in a rotatable manner (trackball), which is located next to the keyboard, is often used as a control unit. The trackball offers the possibility of free positioning or control of the cursor unit in that the movements of the trackball are picked up by mechanical and/or optical sensors and processed as an input signal. These sensors are usually located in the area of the holder in which the ball is mounted.

For the purposes of confirming functions and the like, one or more additional keys are used in this case, as in the case of the computer mouse, which keys are fashioned as separate keys spatially removed from the trackball.

A disadvantage in this respect lies in the fact that the surface or volume of the overall input element is increased by this separate design. Furthermore, operation without direct visual contact is difficult since the user must in fact hit the respective keys. Additionally, for the purposes of calling up functions for example, a plurality of different input elements must be used, that is to say the trackball and the additional key elements.

The object of the present invention is therefore to specify an input element which only takes up a small amount of space or surface and is also easy to operate.

According to the invention, an input element is configured in a corresponding device not only in a movable manner but also in a deformable manner. The movements of the input element allow a cursor unit to be moved on a display unit. Functions, such as the clicking of a button on a user interface, are selected by way of a deformation of the input element. Specifically, the deformation of the input element operates switching elements by way of which corresponding control commands are generated or transmitted to the display unit. These switching elements are located, for example, in the area of a holder by which the input element is held. The use of an input element of this type is intuitive, with the result that information can also be input without visual contact, for example.

In an advantageous embodiment, the input element can be deformed in a plurality of manners where various deformations address different switching elements and therefore functionalities on the display unit.

In a further version, the input element is formed in a ball-shape and preferably displays a shell which is filled with a deformable substance, such as a gel.

Further advantages and versions of the invention are explained on the basis of the figures.

The diagrams show:

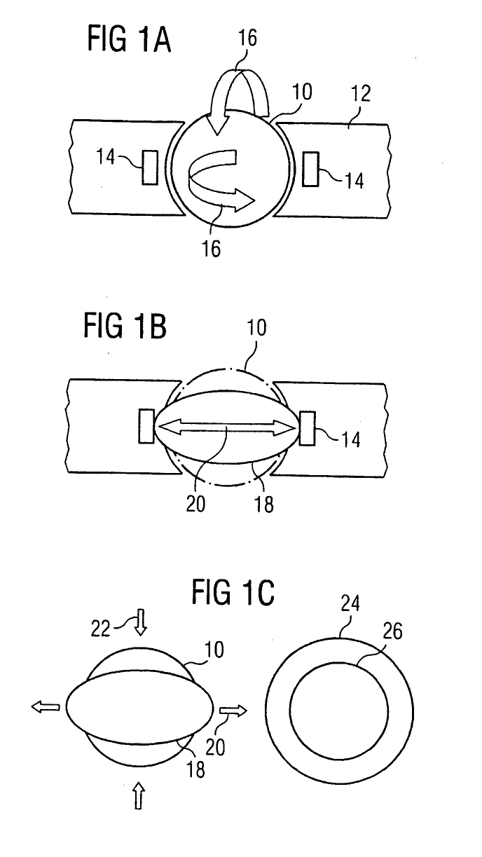

FIG. 1a-1c the operation of a deformable input element and

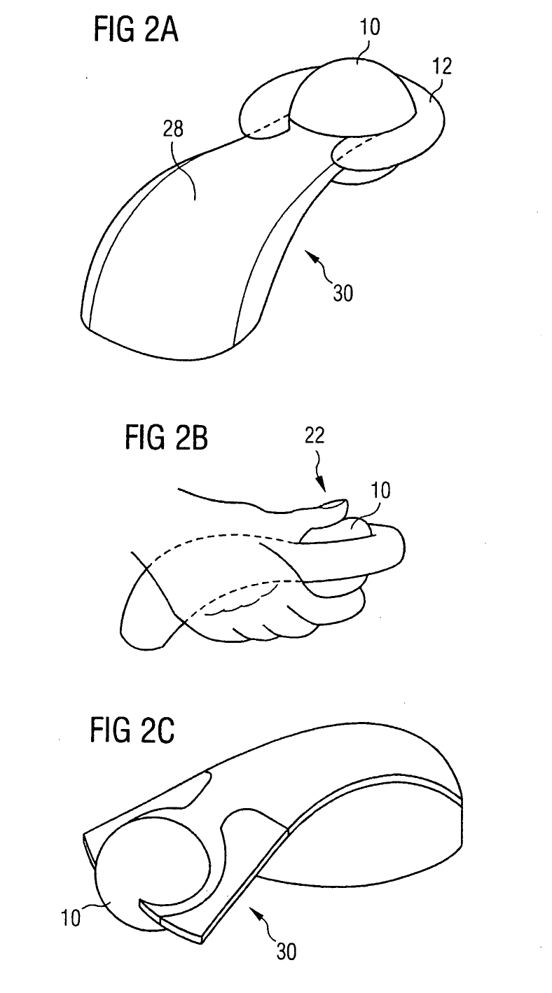

FIG. 2a-2c the design and operation of an input element in a portable appliance.

FIG. 1a shows a trackball 10 as an input element. It is located in a holder 12 in which switching elements 14, which are configured as contacts for example, are located. The trackball 10 is configured as a deformable ball. It is implemented, for example, by means of a fluid, gel-like substance which is enclosed by a flexible membrane. Thus, the trackball 10 can easily be deformed by the effect of external pressure. In the non-deformed state, the trackball 10 has the shape of a ball and can thus be rolled freely in various rotational directions 16 where, for example, the rolling movement is detected by customary electromechanical and/or optical sensors and used for the purposes of the free positioning of a cursor unit on the display unit.

FIG. 1b shows the trackball 10 in the non-deformed state and in the deformed state 18. The direction of deformation 20 is labeled by means of an arrow. When the trackball is in the deformed state 18, it actuates the switching elements 14. The actuation of the switching elements 14 then triggers specific functionalities on the display unit. These involve, for example, the selection of a soft key, i.e. that is to say pressing a so-called button. Therefore, the functions of the positioning of the cursor unit (cursor positioning) and the selection of the functionalities (such as pressing a button) can be carried out with only one input element in the case of a trackball 10 of this type. The operation of the trackball 10 is intuitive and requires no reaching for adjacent keys for the purposes of confirming functions. As a result, an input element of this type is particularly suited to applications without visual contact with the input element.

The surface of the membrane which surrounds the trackball 10 can be designed in any manner, to increase the gripping qualities, for example.

The switching elements 14 can involve contacts or microswitch elements. Furthermore, pressure-sensitive elements are provided as switching elements, such as so-called FSR sensors (FSR=Force Sensitive Resistor). As a result, it is possible to detect the respective strength of the pressure on the trackball 10 as an analog value and use the said value as additional control information. This finds application in games, in particular. For the purposes of better controlling how much pressure is exerted on the trackball 10, a counter-pressure can be generated in addition by means of electromechanical effectors. As a result, the pressure increases with stronger deformation, for example, with the result that the user has the possibility of a more accurate estimation of what pressure he is currently exerting on the trackball 10.

FIG. 1c shows the trackball in the non-deformed and deformed states. The effect of pressure in the direction of pressure 22 brings about a deformation of the trackball 10 in the direction of deformation 20. In the deformed state 18, the trackball has a larger central periphery 24 when seen from above than in the non-deformed state 26 so that the contact with the switching elements 14 is established in this way.

Furthermore, various functionalities can be triggered on the display unit by various degrees of deformation. To this end, a plurality of switching elements 14 is installed in the holder 12, which switching elements are operated individually or in combination as a function of the degree of deformation in the direction of the axis of deformation 20.

Different deformations are also implemented by different directions of pressure, that is to say a direction of pressure 20 being vertical with respect to the holder 12, which effects a “flattening” of the trackball, and also a direction of pressure being horizontal with respect thereto, that is to say essentially parallel to the surface of the holder, which is implemented by a clasping of the trackball, for example, and effects a “longitudinal deformation”.

FIG. 2 shows a version of a device with an input element which is well suited to mobile appliances. The trackball 10 in FIG. 2a is located in a holder 12 which is configured together with a shaped gripping area 28 as an input device 30. The gripping area 28 is configured ergonomically so that it fits well in the hand and the trackball 10, as shown in FIG. 2b, can be easily compressed in the direction of pressure 22.

FIG. 2c shows an embodiment of the input device 30 in which the trackball 10 is partly exposed. In this case, the pressure on the trackball 10 can also be exerted by pressing the input device 30 on a substrate, such as a desktop.

Naturally, the invention is not limited to the examples listed but instead encompasses a large number of further embodiments which are not shown here. In particular, these involve other implementations of the deformability of the input element, such as by way of an elastic material or also a gas or a fluid; shapes of the input element which diverge from the ball shape or are different, such as a stick shape, are also provided. However, these further versions can easily be put into practice by a person skilled in the art on the basis of the information given.

List of Reference Numbers

10 Trackball
12 Holder
14 Switching element
16 Directions of rotation
18 Trackball in the deformed state
20 Direction of deformation
22 Direction of pressure
24 Central periphery in the deformed state
26 Central periphery
28 Gripping area
30 Input device

1. A device (30) with an input element (10) for controlling a display unit,
by means of which a cursor unit can be moved on the display unit, and
the movements of the input element (10) relative to a reference surface are detected by means of a motion detection unit,
characterized by the fact that
the input element (10) is configured in a deformable manner and
switching elements (14) can be operated when the input element (10) is in a deformed state,
by way of which functionalities can be controlled on the display unit.

2. A device as claimed in claim 1,
characterized in that
the input element (10) is mounted in a holder (12).

3. A device as claimed in claim 1 or 2,
characterized in that
the input element (10) can be deformed in at least two different manners and different switching elements (14) can be operated as a function of the manner of the deformation for the purposes of setting different functionalities on the display unit.

4. A device as claimed in one of the preceding claims,
characterized in that
the input element (10) is designed to be ball-shaped or ellipsoid-shaped.

5. A device as claimed in one of the preceding claims,
characterized in that
the input element (10) displays a closed shell of deformable material in which a deformable substance is contained.

6. A device as claimed in claims 5,
characterized in that
the substance displays a gaseous or fluid state of aggregation.
